(19) United States
(12) Patent Application Publication
(10) Pub. No.: US 2024/0301199 A1
(43) Pub. Date: Sep. 12, 2024

(54) MODIFIED CRYSTALLIZED POLYETHYLENE TEREPHTHALATE AND METHOD OF MAKING THE SAME

(71) Applicant: Sonoco Development, Inc., Hartsville, SC (US)

(72) Inventor: Subir K. Dey, Hartsville, SC (US)

(21) Appl. No.: 18/120,102

(22) Filed: Mar. 10, 2023

(51) Int. Cl. C08L 67/02; C08J 3/00; C08J 3/205; C08J 5/18

(52) U.S. Cl. CPC C08L 67/02; C08J 3/005; C08J 3/205; C08J 5/18; C08J 2367/02; C08J 2409/06; C08J 2425/14; C08J 2435/02; C08L 2201/08; C08L 2203/30; C08L 2205/08; C08L 2205/24

(57) ABSTRACT

A modified crystallized polyethylene terephthalate (modified CPET) resin and method of making the same is provided herein. The modified CPET resin comprising crystallized polyethylene terephthalate with a first refractive index, an impact modifier with a second refractive index, and a compatibilizer with a third refractive index. The second refractive index is within (0.05 to 0.02) of the first refractive index, and the third refractive index is within (0.05 to 0.02) of the first refractive index.

### FIELD OF THE INVENTION

Embodiments of the present invention relate generally to packaging for food products, and more particularly to a packaging which is clear when amorphous and opaque when crystallized.

### BACKGROUND

Thermoformed polyethylene terephthalate (PET) trays are formulated to withstand specified cold temperature impact to resist breakage, for example when dropped while at freezer temperature. To achieve this property, a thermoplastic elastomer and other additives are added to crystallized polyethylene terephthalate (CPET) resin. The addition of the thermoplastic elastomer, for example, an impact modifier, and other additives produce an opaque CPET blend. Thus, when thermoformed the resulting container displays a high haze, and may not qualify for use in certain products, e.g., clear water bottles. Further, the resulting high haze of the CPET resin prevents recycling of the material in a regular PET stream due to the high haze present in the recycled resin/products.

### BRIEF SUMMARY

The present invention is a clear and/or transparent, impact resistant modified CPET resin which may be used to form thermoformed products with cold temperature impact properties. The modified CPET resin exhibits low haze when not crystallized (e.g., an amorphous sheet), and may become opaque when crystallized. If, after crystallization, the modified CPET resin is introduced into a regrind or recycling operation to be re-extruded into an amorphous sheet, the modified CPET resin regrind returns to a clear and/or low haze coloration.

Current blends of CPET resin utilize known additives which provide the desired properties. However, the additives and the CPET resin are generally not miscible, thereby creating a major phase and a minor phase within the resin. The two phases may cause light to scatter within the resin and/or the product, thereby creating unacceptable haze and or opaque coloration. More particularly, the differences in the refractive indices of the phases, (a measurement of the bending of a ray of light when transitioning between mediums) cause light waves to continually scatter within the CPET when the light waves contact the additive phase. The phases are additionally not separable during recycling and thus may not be used in future products which require low haze and or clear coloration. Similarly, the CPET resins may not be used for certain first use products, for example clear water bottles or other materials which require low haze or clear coloration.

One of the ways, modified CPET may be formed by matching the refractive indices of the CPET resin and any additives (e.g., impact modifier and/or compatibilizer). By matching refractive indices, light will not scatter within the CPET and thus, will produce a low haze appearance.

In an example embodiment a modified crystallized polyethylene terephthalate resin is provided. The modified crystallized resin comprises a crystalized polyethylene terephthalate resin with a first refractive index, an impact modifier with a second refractive index, and a compatibilizer with a third refractive index. The second refractive index is within 0.05 to 0.02 of the first refractive index. The third refractive index is within 0.05 to 0.02 of the first refractive index.

In some embodiments, the impact modifier may be styrene-butadiene. In some embodiments, the impact modifier may be a non-reactive copolymer. In some embodiments, the compatibilizer may be an alternating styrene-maleic anhydride. In some embodiments, the modified crystallized polyethylene terephthalate resin may further comprise a free radical scavenger. In some embodiments, the modified crystallized polyethylene terephthalate resin may further comprise a stabilizer. In some embodiments, the modified crystallized polyethylene terephthalate resin may further comprise a nucleating agent. In some embodiments, the modified crystallized polyethylene terephthalate resin may be clear in the amorphous state.

In some embodiments, a monolayer formed sheet may be formed from the modified crystallized polyethylene terephthalate resin. In some embodiments, the first refractive index, the second refractive index, and the third refractive index may be within 0.02 of each other. In some embodiments, a thermoformed container may be formed from the modified crystallized polyethylene terephthalate resin.

In yet another example embodiment a method of making a container is provided. The method comprises blending crystallized polyethylene terephthalate, defining a first refractive index with an impact modifier, defining a second refractive index, and a compatibilizer defining a third refractive index. The second refractive index is within 0.05 to 0.02 of the first refractive index. The third refractive index is within 0.05 to 0.02 of the first refractive index. The method continues by extruding the blended mixture.

In some embodiments, the method may further comprise mixing the modified crystallized polyethylene terephthalate with a nucleating agent, and drying the mixture. In some embodiments, the method may further comprise pelletizing the extrusion, drying the pelletized material, extruding the dried pelletized material, and thermoforming the extruded material. In some embodiments, the dried mixture may further comprise a stabilizer. In some embodiments, the impact modifier may be styrene-butadiene. In some embodiments, the impact modifier may be an alternating styrene-maleic anhydride. In some embodiments, the thermoformed extruded material may be clear. In some embodiments, the thermoformed extruded material may be a monomaterial.

In yet another example embodiment a dry blend of crystallized polyethylene terephthalate configured for injection molding is provided. The dry blend comprises a crystalized polyethylene terephthalate resin with a first refractive index, an impact modifier with a second refractive index, and a compatibilizer with a third refractive index. The second refractive index is within 0.05 to 0.02 of the first refractive index. The third refractive index is within 0.05 to 0.02 of the first refractive index.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example layered CPET, in accordance with some embodiments discussed herein;

FIG. 2 illustrates an example monolayer modified CPET in accordance with some embodiments discussed herein;

FIG. 3 illustrates a flow chart of an example method of forming the modified CPET, in accordance with some embodiments discussed herein;

FIG. 4A illustrates CPET samples, in accordance with some embodiments discussed herein;

FIG. 4B illustrates the CPET samples shown in FIG. 4A after thermoforming, in accordance with some embodiments discussed herein;

FIG. 5A-B illustrate a CPET sample, in accordance with some embodiments discussed herein;

FIG. 5C illustrates the CPET sample shown in FIGS. 5A-B after thermoforming, in accordance with some embodiments discussed herein;

FIG. 6A-B illustrate a CPET sample, in accordance with some embodiments discussed herein;

FIG. 6C illustrates the CPET sample shown in FIGS. 6A-B after thermoforming, in accordance with some embodiments discussed herein;

FIG. 7A-B illustrate a CPET sample, in accordance with some embodiments discussed herein; and

FIG. 7C illustrates the CPET sample shown in FIGS. 7A-B after thermoforming, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Like reference numerals refer to like elements throughout.

In an embodiment, the invention provides a modified crystalized polyethylene terephthalate (modified CPET) capable of being recycled and used in products with a clear or low haze color requirement. In an embodiment the modified CPET resin may be used as virgin or recycled resin to form containers and other substrates which have haze requirements.

Traditional CPET resin may include thermoplastic elastomers, impact modifiers and other additives which modify the chemical and physical properties of the CPET resin to withstand specified cold temperature impact and resist breakage. In this regard, although the additives contribute to the desired traits of the CPET resin, these additives also contribute to the coloration/transparency/haze of the CPET resin when amorphous and/or crystallized even though the additives themselves may be colorless.

The coloration transparency, haze, and/or opacity of the thermoformed product may affect the recyclability of the product, as the regrind CPET material may maintain the opacity of the previous thermoformed product. Thus, the recycled regrind may not be able to be used in certain manufacturing processes, as some recycled products must meet color, transparency, haze and/or opacity requirements.

For example, when an opaque CPET is blended with a regrind from clear water bottles (e.g., PET) to form a recycled water bottle, even at a ratio of 5:95%, the resulting mixture may exhibit unacceptable opacity within the resulting recycled product and may not qualify to be used in a recycled water bottle production or other recycled product which requires clarity, or low haze rather than an opaque coloration.

Thus, it may be desirable to have a CPET tray and/or sheet with cold temperature impact resistance, while maintaining low haze or the ability to see through the CPET, such that a consumer may see the products within the tray or opposite the sheet, and that is able to be introduced into a recycle stream and used within future recycled products requiring a low haze coloration.

In an embodiment, a modified CPET resin may be formed of CPET resin, an impact modifier, and/or other additives such that when crystalized, the modified CPET may be opaque, however, in the amorphous state, may exhibit a low haze or clear coloration or transparency. In some embodiments, the modified CPET may exhibit a low haze or may be transparent when introduced into a regrind process.

Without wanting to be bound by theory, it is believed that the incompatibility of the impact modifiers and/or other additives within the modified CPET may cause the opacity within the resulting product. In products which exhibit a major phase and a minor phase, the variation between physical and or chemical characteristics may cause light to scatter within the product (e.g., thermoformable sheet) and create the opacity within the resulting product.

For example, CPET resin modified with ethylene methyl acrylate copolymer (EMA), creates an immiscible mixture, as the two components are not miscible. In this regard, when the components are mixed together the CPET resin becomes the major phase, and the EMA becomes the minor phase. Each of the components defines physical and chemical characteristics including average particle size and refractive indices. The refractive index is an optical property of the component which compares the velocity of light in a vacuum to the velocity of light through the material. EMA may define an average particle size between 0.5-2 microns in diameter, with some particles being larger and others being smaller. Further, EMA may define a refractive index of about 1.47. CPET may be continuous and may define a refractive index of about 1.575.

Additional factors to consider in the coloration of the CPET is the wavelength of visible light. In general, the wavelength of visible light may be between 400-700 nm. Thus, the wavelength of visible light is much smaller than the size of the EMA particles. In this regard, materials comprising particles defining a particle size greater than the wavelength of light will cause the light to reflect internally. Thus, the EMA particles cause light to reflect within the CPET resin and create an opaque color within the CPET resin.

Therefore, in a blend of CPET resin and EMA, where the CPET resin is in a continuous phase (e.g., major phase) and EMA is used as an additive (e.g., in the minor phase), the resulting CPET sheet will be hazy or opaque. The volume of EMA may affect the level of haze in the resin. For example, a high volume of EMA may cause opacity while a lower volume of EMA may cause haze.

In this regard, although the CPET resin and EMA mix, the two components maintain distinct refractive indices, and the resulting tray comprises multiple refractive indices corresponding to the CPET and the EMA. Thus, rather than having a single refractive index the CPET and EMA mixture maintain their individual refractive indices, and thus, the light scatters and causes the haze/opacity of the resulting product.

Thus, to prevent the light scattering within the product due to the different refractive indices of the components used in forming the product, through hard work and ingenuity, the inventors have developed a sheet product which may be formed utilizing components having similar refractive indices, reducing or preventing the internal refraction of light, thereby yielding a clear or low haze product.

In some embodiments, a modified CPET may be formed into a sheet configured to be thermoformed. The modified CPET sheet may exhibit clear to low haze. In some embodiments, the sheet may be configured for recycling because it exhibits the recycling characteristics required for manufacture of a recycled product.

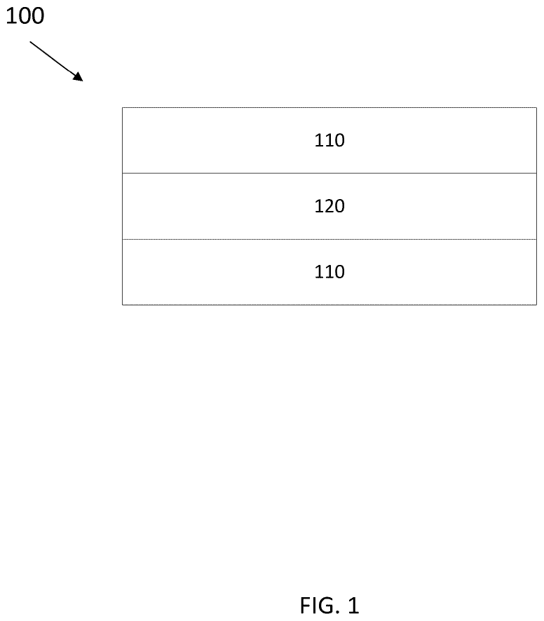

An example CPET structure 100 meeting standard coloration and impact goals is illustrated in FIG. 1. FIG. 1 illustrates a layered sheet 100 which exhibits low haze when utilized, however may appear, and/or cause an opaque coloration when introduced to a regrind process, or used in a recycled material as will be explained below. The layered CPET sheet 100 may be formed by coextruding layers of CPET 110 and EMA 120. The layer(s) of EMA 120 may provide the CPET sheet 100 with the necessary impact characteristics, including sufficiently high frozen impact resistance. In this example it is likely that due to the homogeneity within each of the layers, light will be able to pass through each layer 110, 120 without additional scattering, thus, yielding a clear or low haze modified CPET sheet 100.

However, unless each of the layers 110, 120 are separated prior to the regrind process (which is not practical), the resulting regrind pellets will comprise both CPET and EMA, yielding a high haze or opaque regrind. To explain, by layering the CPET 110 and the EMA 120 the particles were separated, and thus, the EMA particles did not create internal reflection within the CPET layer 110. However, when introduced into the regrind process, the CPET and the EMA will become mixed and thus, cause the internal reflection within the resulting regrind pellets, and any products created therefrom, thereby creating an opaque or high haze recycled product.

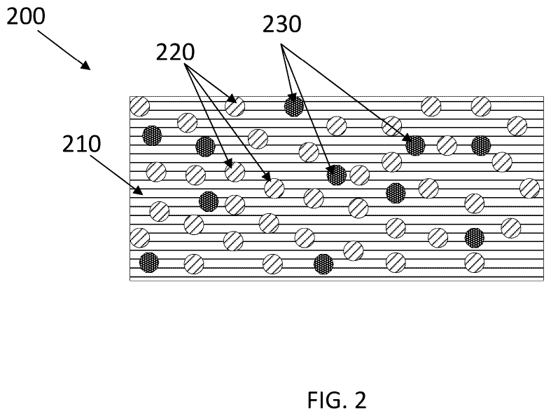

In contrast, the inventive composition is a modified CPET which exhibits cold/frozen impact properties, while maintaining low haze and/or clear coloration during forming and upon regrind for use in recycled products. An inventive modified CPET sheet 200, is illustrated in FIG. 2. The inventive modified CPET sheet 200 may be a monolayer material comprising CPET 210 defining a first refractive index, an impact modifier 220 defining a second refractive index, and a compatibilizer 230 defining a third refractive index. Each of the first refractive index, the second refractive index and the third refractive index may be similar or may even be the same. In this regard, when the refractive indices of the components are matched, there will be little internal reflection, yielding a low haze or clear modified CPET sheet. Thus, the modified CPET sheet 200 may comprise the desired characteristics including high frozen impact resistance while meeting the coloration requirements.

As discussed above, each component defines a refractive index. In this regard, differences in the refractive indices of components within the same product may cause internal reflection and a resulting coloration including haze. Thus, in order create a modified CPET composition to be used within a thermoformable sheet exhibiting a low haze or clear appearance based on the refractive indices of the components, the refractive indices must be closely matched so as to reduce or eliminate the internal reflection which causes coloration (e.g., haze) within the product.

In general, many polymers define refractive indices between 1.3-1.7. Thus, to determine a modified CPET resin composition which exhibits the desired impact resistance, and low haze to clear haze, the components must define similar refractive indices.

As discussed with reference to CPET (refractive index 1.575) and EMA (refractive index 1.47) the difference between the refractive indices is about 0.1. Thus, as discussed above a refractive index of 0.1 creates an opaque coloration within the substrate, indicating that a substrate with a clear/low haze coloration may comprise components defining refractive indices with less than a 0.1 difference between each of the components of the resulting substrate. In this regard, the difference in the refractive indices of the components within the modified CPET resin must be less than 0.1.

In some embodiments, the inventive modified CPET resin may comprise CPET resin with a first refractive index, an impact modifier with a second refractive index, and a compatibilizer with a third refractive index. In an embodiment, the difference between the highest refractive index of the first, second, or third refractive index, and the lowest refractive index of the first, second, or third refractive index may be less than 0.1.

In some embodiments, the difference between the highest refractive index of the first, second, or third refractive index, and the lowest refractive index of the first, second, or third refractive index may be less than 0.05, and even more preferably may be less than 0.04. In some embodiments, the difference in the first refractive index and the second refractive index may be less than 0.1, less than 0.05, or more preferably less than 0.02. In some embodiments, the difference between the first refractive index and the third refractive index may be less than 0.1, less than 0.05, or more preferably less than 0.02.

In some embodiments, the CPET resin may be a commercial CPET resin, for example Auriga 7800 CPET or Eastlon 8906. In some embodiments, the CPET resin may define a nominal intrinsic viscosity of 0.89. In some embodiments, the CPET resin may define a clear color and may define a refractive index of 1.575.

Thus, the additives must define refractive indices close to that of CPET resin, as CPET resin will be the main component of the modified CPET resin. In some embodiments, the impact modifier may be a copolymer, or terpolymer defining a refractive index within 0.05 or more preferably within 0.02 of 1.575, the refractive index of the CPET resin. In some embodiments, the refractive index of the impact modifier may be between 1.525-1.625, and more preferably between 1.555-1.595.

In some embodiments, the refractive index of a copolymer or terpolymer may be bound between the refractive index of each of the polymers in the copolymer or terpolymer. For example, an ethylene and methyl acrylate copolymer would define a refractive index bound by the refractive index of ethylene and the refractive index of methyl acrylate. To explain, polymethyl acrylate, defines a refractive index of 1.4793, and low density polyethylene defines a refractive index of 1.51. Thus, a random ethylene methyl acrylate copolymer may define a refractive index between 1.4793 and 1.51. In this regard, when a greater amount of polymethyl acrylate is used within the copolymer, the copolymer refractive index define a difference of more than 0.09 of the refractive index of CPET resin, and thus, would not be useable as an impact modifier, within the modified CPET.

In this regard, the refractive index of a copolymer may correspond to the composition of the copolymer, for example, the weight percent of each of the polymers of the copolymer. Thus, if the copolymer comprises a larger amount of a first polymer, e.g., polymethyl acrylate and a smaller amount of a second polymer, e.g., low density polyethylene, the refractive index of the first polymer may be weighted higher, and thus, the refractive index of the copolymer may be closer to the refractive index of the first polymer.

In the inventive modified CPET the impact modifier may be a nonreactive copolymer. In some embodiments, the impact modifier may be a styrene-butadiene copolymer comprising poly(1,2-butadiene) and polystyrene, for example Styroflex® family of resins. There are other producers of random copolymers of Styrene and butadiene. In this regard, poly(1,2-butadiene) defines a refractive index of about 1.500, and polystyrene defines a refractive index of about 1.5894. Thus, a random copolymer of styrene-butadiene, may define a refractive index between 1.50-1.5894. Thus, if the copolymer comprises more polystyrene, the refractive index will be closer to 1.589 which is within 0.05 of the refractive index of the CPET resin, and more preferably within the 0.02 of the refractive index of the CPET. In some embodiments, the impact modifier may define a refractive index of about 1.58.

In some embodiments, a compatibilizer may be added to the CPET resin with the impact modifier to promote adhesion there between. The compatibilizer may further modify interfacial character and stabilize its morphology against stresses. To explain, CPET and styrene-butadiene copolymer are chemically dissimilar. The compatibilizer may be utilized to produce smaller dispersed phase morphology. In some embodiments, the compatibilizer may comprise a reactive molecule grafted on the rubber phase (e.g., the impact modifier). Thus, including the PET within the compatibilizer may induce create a refractive index close to the CPET.

In some embodiments the compatibilizer may be alternating styrene-maleic anhydride (SMA). SMA has a refractive index of about 1.564 which is within the 0.05 and more preferably within the 0.02 range for the desired matching refractive index. Further, advantages of SMA may include the SMA comprises an alternating polymer with a relatively high reactive group, (e.g., maleic anhydride), and SMA is clear when not combined with an impact modifier. Further, SMA may react with CPET at the desired operating temperature, and may be able to receive all necessary food safety clearances.

Although SMA is hygroscopic and may lose the reactivity when exposed to moisture, the modified CPET resin, including SMA may be dried, and the SMA may regain the reactivity. In some embodiments, the SMA may be XiBond 120, XiBond 130, or modified Kraton 1901X.

In some embodiments, the modified CPET may further include a stabilizer. In this regard the stabilizer may be configured to stabilize the impact modifier. To prevent the degradation a stabilizer may be utilized during drying and extrusion. In some embodiments, the stabilizer may be a phenolic antioxidant, a processing stabilizer, and a thermal stabilizer, for example, Ethanox 330, Irganox 1010, Sumilizer GM, and BNX 549.

In some embodiments, the CPET resin may comprise a nucleating agent. In some embodiments, the nucleating agent may be an inorganic compound, for example talc. In some embodiments, the nucleating agent may be an antioxidant, for example Ethanox 330. In some embodiments, the nucleating agent may dissolve into the CPET, while in other embodiments the nucleating agent may not dissolve, and may contribute to the haze, and/or the opacity of the modified CPET resin. In some embodiments, the nucleating agent may comprise less than 3% of the total solution by weight, more preferably less than 2% of the modified CPET resin, and in some embodiments may be less than 1% of the modified CPET resin. In some embodiments, the CPET resin may further comprise a free radical scavenger. In some embodiments, the free radical scavenger may increase stability.

In some embodiments, the modified CPET may comprise at least 80% CPET resin, at least 85% CPET resin, at least 90% CPET resin, at least 95% CPET resin or even up to 99% CPET resin by weight. In this regard, a greater weight percent of CPET resin may result in a clearer CPET, however the high weight percent of CPET resin may reduce the impact properties of the CPET. In some embodiments, the modified CPET may comprise at least 3% impact modifier, at least 6% impact modifier or even at least 9% impact modifier by weight. In some embodiments, the modified CPET may comprise between 1%-20% impact modifier by weight.

In some embodiments, the modified CPET may comprise at least 0.5% compatibilizer, at least 1.0% compatibilizer, or even at least 1.5% compatibilizer. In some embodiments, the modified CPET may comprise between 0.1%-5% compatibilizer by weight.

In some embodiments, the modified CPET is clear when amorphous. In some embodiments, the blend may become opaque when crystallized. However, upon regrind of the modified CPET, (e.g., for use in recycled products) when the regrind is re-extruded into an amorphous sheet the modified CPET resin returns to clear.

### Method of Manufacture

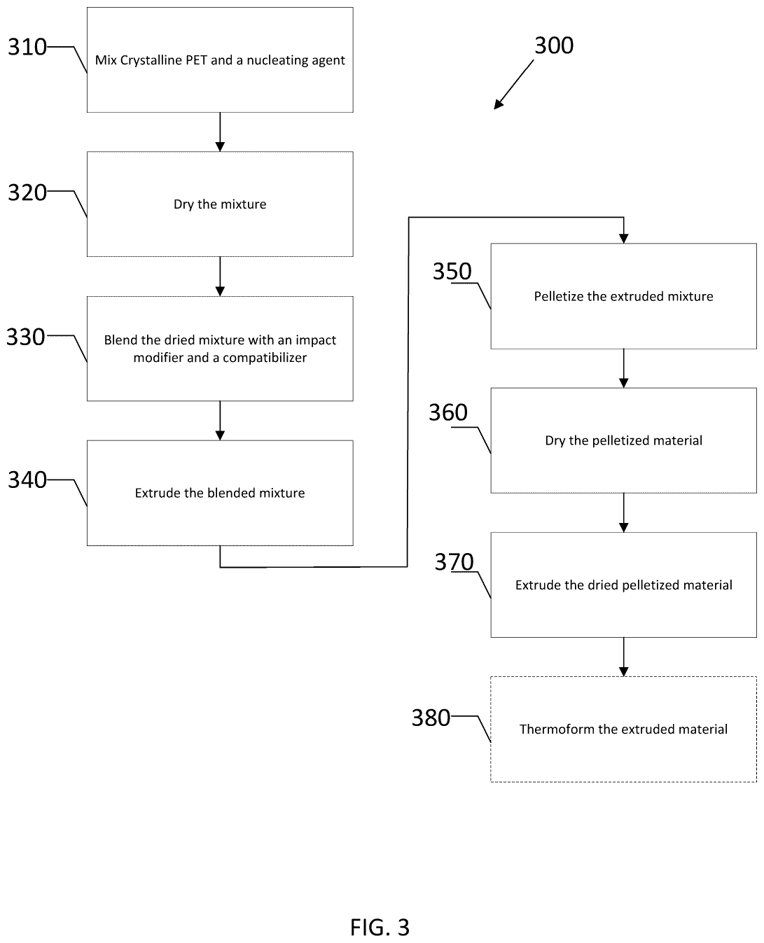

In some embodiments, the modified CPET resin may be manufactured by the method 300 illustrated in FIG. 3. In some embodiments, at operation 310 the CPET resin batch may be mixed with the nucleating agent. In some embodiments, the nucleating agent may comprise between 0.1%-5% of the bath mixture by weight. In some embodiments, illustrated at operation 320, the mixture may be dried in an oven, at a temperature of at least 250° F., at least 275° F., or 300° F. In some embodiments, the oven temperature may exceed 300° F. In some embodiments, the mixture is dried for at least 3 hours, at least 5 hours, or more preferably at least 8 hours. In some embodiments, the mixture may be cooled prior to removal from the oven.

In some embodiments, the oven may be a vacuum oven. In some embodiments, the vacuum oven may be purged with dry nitrogen prior to removal of the mixture. In this regard, the nitrogen purge may prevent oxidation, which may cause the mixture to change to an undesired color.

After cooling and removal from the oven, at operation 330, the impact modifier, compatibilizer and optionally a stabilizer may be added and blended with the mixture as needed. In some embodiments, the mixture may be dry blended. After mixing the dry mixture may be extruded, at operation 340. In some embodiments, the extruder may be a single screw extruder, a twin screw extruder or other plasticating machines known in the art. In some embodiments, the dried mixture may be extruded at a temperature of at least 500° F., at least 520° F. or at least 535° F. In some embodiments, the extruder may rotate at least 50, 100, 200, 350 RMP, 400 RMP, or at least 450 RPM. In some embodiments, a double vacuum may be applied within the extruder. In some embodiments, at operation 350, the extruded strands may be cooled and pelletized. In some embodiments, the extruded strands may be cooled with water, or other cooling liquid.

In some embodiments, at operation 360, the compounded strand pelletized material may be dried in an oven of a temperature of at least 200° F., at least 250° F., or at least 300° F. In some embodiments, the pelletized material may clump, as such the clumps may be broken and dried in the oven for at least 3 hours, at least 5 hours, or at least 8 hours. In some embodiments, after drying the dried pelletized material may be cooled prior to removal from the oven.

In some embodiments, at operation 370, the dried pelletized material may be extruded into a modified CPET sheet. In some embodiments, the modified CPET sheet may be 20 mils thick, and 8 inches wide. In some embodiments, the second extrusion may utilize a single screw extruded, a twin screw extruder, or other plasticating machine known in the art.

Optionally, in some embodiments, at operation 380. the modified CPET sheet may be thermoformed into the desired container. In some embodiments, the modified CPET sheet may be thermoformed into cups. In some embodiments, the thermoforming mold may not be heated so as to prevent the modified CPET sheet from becoming crystallized, and thus retaining the low haze or clear appearance of the molded modified CPET. To achieve crystallized containers, the mold may be heated to a temperature so that CPET crystallization is achieved, in which case, the container will be translucent to opaque for visible light.

### EXAMPLES

The following examples describe various embodiments of the present invention.

Other embodiments within the scope of the claims will be apparent to one skilled in the art from consideration of the specification or practice of the invention as disclosed herein. It is intended that the examples, together with the examples, be considered to be exemplary only, with the scope and spirit of the invention being indicated by the claims which follows the specification. In the examples, all percentages are given on a weight basis unless otherwise indicated.

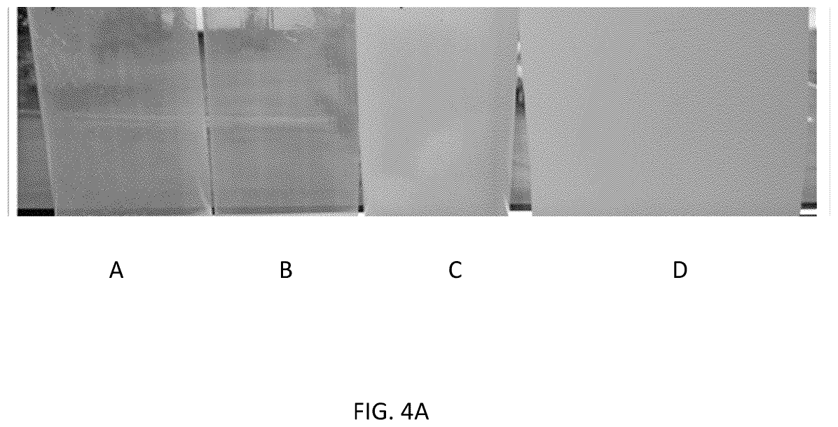

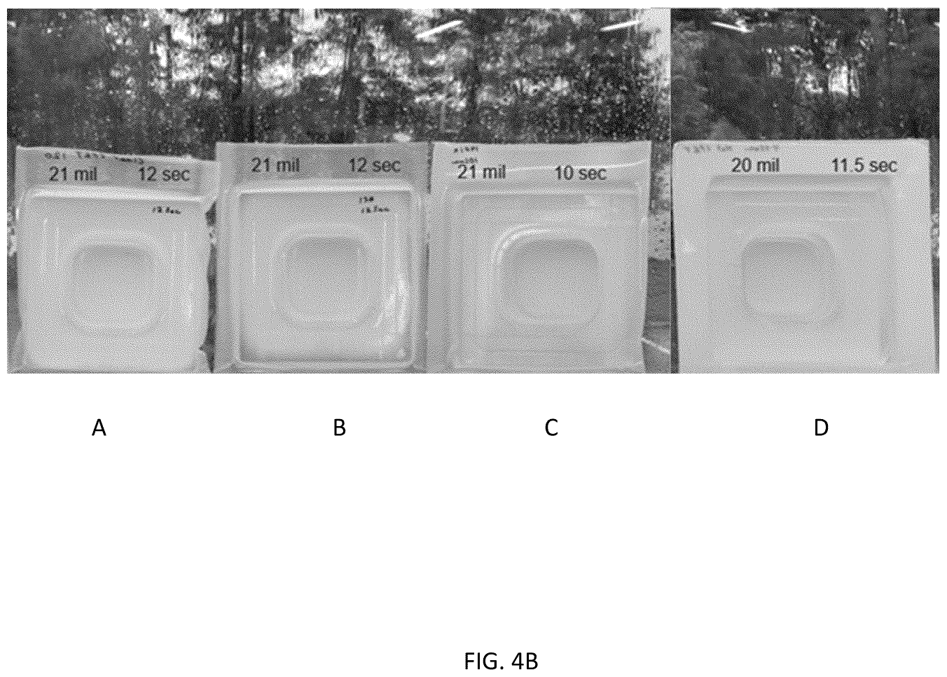

FIG. 4A shows three different modified CPET sheets and a prior art CPET sheet (sample D) prior to thermoforming, and FIG. 4B illustrates a container thermoformed from each of the modified CPET sheets and the prior art CPET sheet. Each of the sheets was positioned in an oven for 12 seconds and then measured for crystallinity, intrinsic velocity (IV), and sheet clarity. The sheet clarity was determined by positioning the sheet over a text or object and determining the amount of text that was able to be seen through the sheet. Each of samples A-C utilize the same CPET resin with a different compatibilizer.

TABLE 1

| | Oven Time | % Crystallinity | IV | Sheet Clarity |
|---|---|---|---|---|
| A | 12 seconds | 12.4 | 0.7 | 88.5 |
| B | 12 seconds | 12% | 0.7 | 90.5 |
| C | 12 seconds | 11.3% | 0.74 | 33.8 |
| D (prior art) | 12 seconds | 10.5% | 0.76 | 12.6 |

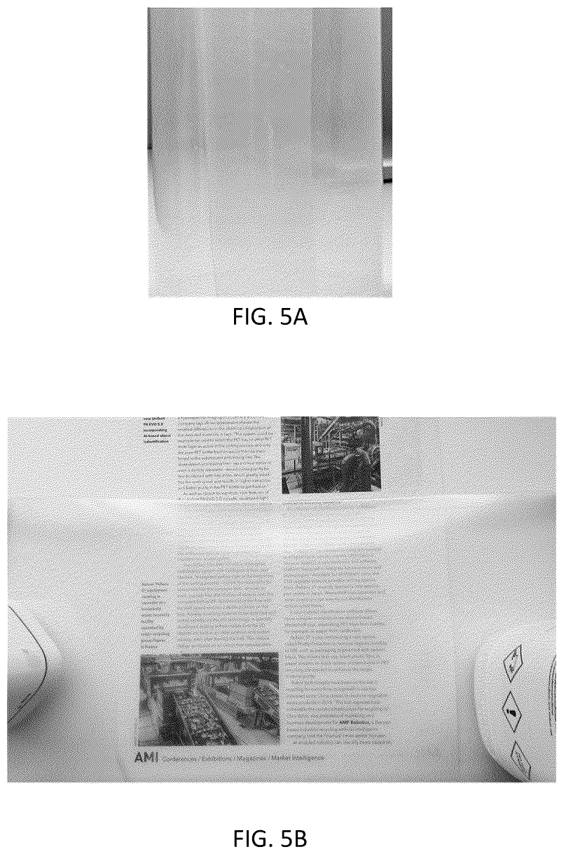

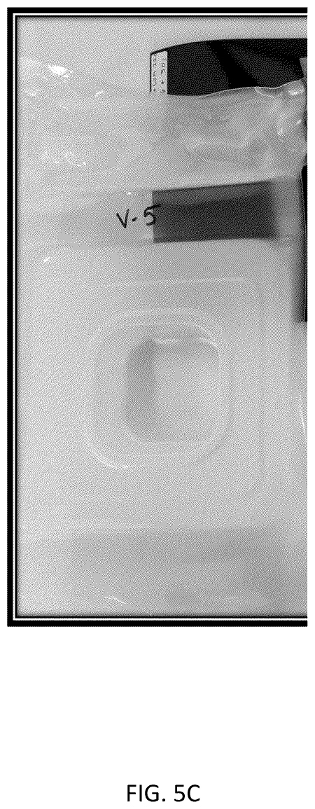

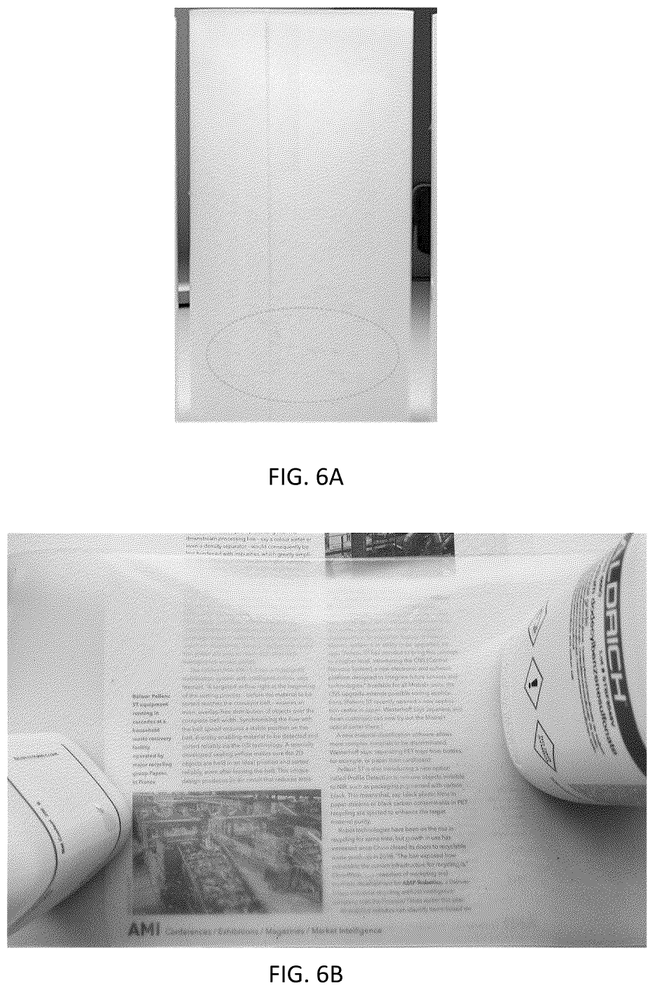

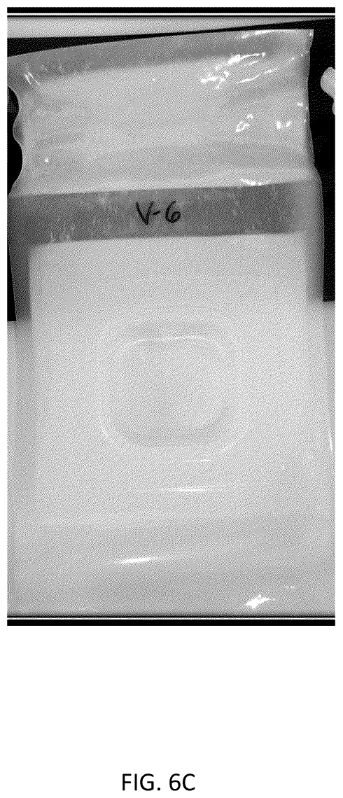

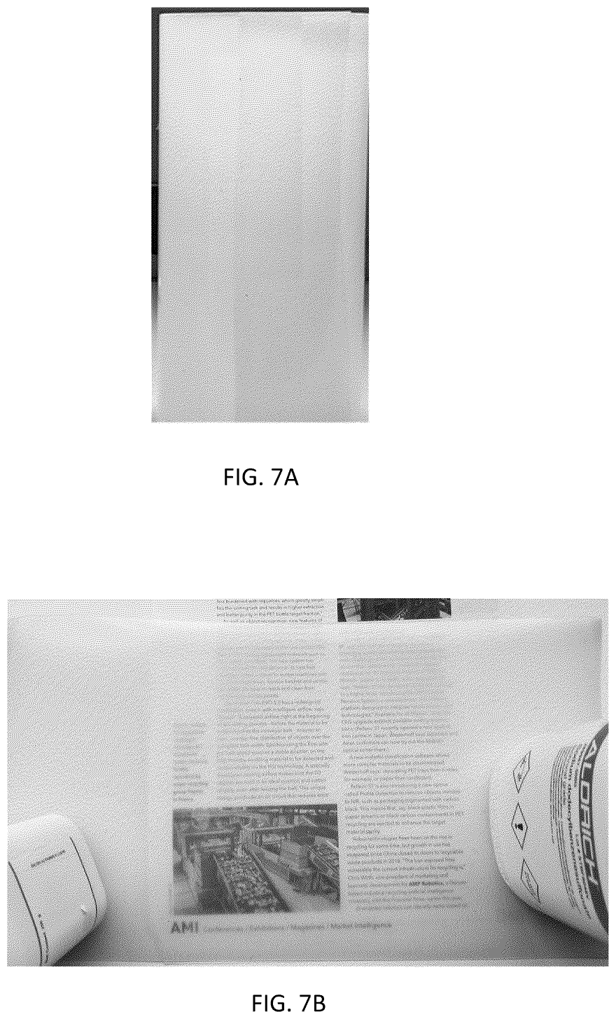

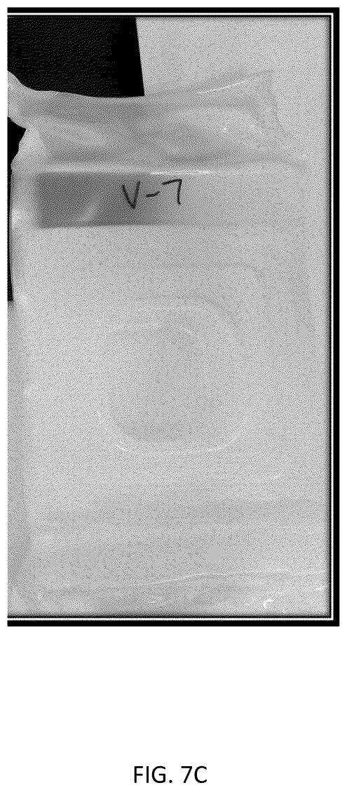

FIGS. 5A-7C illustrate a modified CPET compositions before and after thermoforming. FIGS. 5A-B illustrate the haze/clarity of a first composition utilizing a CPET and an impact modifier in accordance with the invention. The composition of the sheet is 90.5% CPET, and 9.5% impact modifier. Before thermoforming, illustrated in FIGS. 5A-B the modified CPET sheet is clear. After thermoforming, the thermoformed portion of the modified CPET sheet is opaque, while the unthermoformed portion (e.g., the web) remains clear. The unthermoformed web is clear as the CPET was not crystallized. FIGS. 6A-B illustrate the CPET shown in FIGS. 5A-B further comprising a compatibilizer. The composition of the modified CPET is 89% CPET, 9.5% impact modifier and 1.5% clear compatibilizer. Before thermoforming, illustrated in FIGS. 6A-B the modified CPET sheet exhibits slightly greater haze than in FIGS. 5A-B. After thermoforming, the thermoformed portion of the modified CPET sheet is opaque, while the unthermoformed portion retains the clarity illustrated in FIGS. 6A-B. FIGS. 7A-B illustrate the CPET shown in FIGS. 6A-B, further comprising talc. The composition of the modified CPET is 86% clear CPET, 9.5% impact modifier, 1.5% compatibilizer, and 3% talc. Before thermoforming, illustrated in FIGS. 7A-B the modified CPET sheet exhibits more haze than the modified CPET shown in FIGS. 6A-B. After thermoforming, the thermoformed portion of the modified CPET sheet is opaque, while the unthermoformed portion retains the same clarity illustrated in FIGS. 7A-B. As illustrated in the progression from FIG. 5A to FIG. 7C, the more additives included in the modified CPET the less clear the composition prior to thermoforming.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A modified crystallized polyethylene terephthalate resin comprising:
a crystallized polyethylene terephthalate with a first refractive index;
an impact modifier with a second refractive index, wherein the second refractive index is within 0.05 to 0.02 of the first refractive index; and
a compatibilizer with a third refractive index, wherein the third refractive index is within 0.05 to 0.02 of the first refractive index.

2. The modified crystallized polyethylene terephthalate resin of claim 1, wherein the impact modifier is styrene-butadiene.

3. The modified crystallized polyethylene terephthalate resin of claim 1, wherein the impact modifier is a non-reactive copolymer.

4. The modified crystallized polyethylene terephthalate resin of claim 1, wherein the compatibilizer is alternating styrene-maleic anhydride.

5. The modified crystallized polyethylene terephthalate resin of claim 1, further comprising a free radical scavenger.

6. The modified crystallized polyethylene terephthalate resin of claim 1, further comprising a stabilizer.

7. The modified crystallized polyethylene terephthalate resin of claim 1, further comprising a nucleating agent.

8. The modified crystallized polyethylene terephthalate resin of claim 1, wherein the modified crystallized polyethylene terephthalate is clear in the amorphous state.

9. A monolayer formed sheet comprising the modified crystallized polyethylene terephthalate resin of claim 1.

10. The modified crystallized polyethylene terephthalate resin of claim 1, wherein each of the first refractive index, the second refractive index, and the third refractive index are within 0.02 of each other.

11. A thermoformed container formed from the modified crystallized polyethylene terephthalate resin of claim 1.

12. A method of making a container, the method comprising:
blending crystallized polyethylene terephthalate with an impact modifier, wherein the crystallized polyethylene terephthalate defines a first refractive index, and the impact modifier defines a second refractive index wherein the second refractive index is within 0.05 to 0.02 of the first refractive index and a compatibilizer defining a third refractive index, wherein the third refractive index is within 0.05 to 0.02 of the first refractive index; and
extruding the blended mixture.

13. The method of claim 12, further comprising mixing the crystallized polyethylene terephthalate with a nucleating agent; and
drying the mixture.

14. The method of claim 12, further comprising:
pelletizing the extrusion;
drying the pelletized material;
extruding the dried pelletized material; and
thermoforming the extruded material.

15. The method of claim 12, wherein the dried mixture further comprises a stabilizer.

16. The method of claim 12, wherein the impact modifier is styrene-butadiene.

17. The method of claim 12, wherein the impact modifier is alternating styrene-maleic anhydride.

18. The method of claim 12, wherein the thermoformed extruded material is clear.

19. The method of claim 12, wherein the thermoformed extruded material is a monomaterial.

20. A dry blend of crystallized polyethylene terephthalate wherein the blend is configured for injection molding, the blend comprising:
a crystallized polyethylene terephthalate with a first refractive index;
an impact modifier with a second refractive index, wherein the second refractive index is within 0.05 to 0.02 of the first refractive index;
a compatibilizer with a third refractive index, wherein the third refractive index is within 0.05 to 0.02 of the first refractive index.
